(19) United States
(12) Patent Application Publication
(10) Pub. No.: US 2008/0268278 A1
(43) Pub. Date: Oct. 30, 2008

(54) WEIGHT SETS

(76) Inventor: Susan R. Walsh, Brooklyn, NY (US)

Correspondence Address: K&L Gates LLP, STATE STREET FINANCIAL CENTER, One Lincoln Street, BOSTON, MA, 02111-2950, US

(21) Appl. No.: 12/112,589

(22) Filed: Apr. 30, 2008

Related U.S. Application Data
(60) Provisional application No. 60/926,872, filed on Apr. 30, 2007.

(51) Int. Cl. B32B 15/02; B32B 15/08

(52) U.S. Cl. 428/600

(57) ABSTRACT

Free weights for strength training or other athletic endeavors are provided. The free weights according to the present invention can provide a non-traditional, comfortable look and feel to users, and can reduce user intimidations to promote the use of the free weights and the resulting health benefits.

### RELATED APPLICATIONS

This application claims priority to and the benefit of U.S. Provisional Patent Application No. 60/926,872, filed Apr. 30, 2007, the entire disclosure of which is hereby incorporated by reference herein.

### FIELD OF THE INVENTION

The present invention relates to free weights that can provide a non-traditional, comfortable look and feel to users. These weights are appropriate for use in a broad range of contexts and can promote the use of the free weights and the resulting health benefits.

### BACKGROUND OF THE INVENTION

Strength training provides myriad physical and mental benefits to those that practice it on a regular basis. Strength training, among other things, 1) makes it easier to perform daily activities such as those that require pushing, pulling, and lifting; 2) creates strong ligaments and tendons, which in turn support joints and help to prevent injury; 3) increases bone density, which can help prevent osteoporosis, an especially important concern for women; 4) increases the resting metabolism, thus assisting with fat burning and weight loss; 5) promotes good cardiac function; and 6) helps maintain a good cholesterol level. Strength training can also provide a boost in confidence resulting from the physical changes that accompany such training.

While modern society has embraced strength training and its numerous benefits, most free weight strength training equipment remains trapped in its original 19^{th} century form. For example, the dumbbell, a widely used free weight that has two equal weights attached at either end of a handle, has maintained its shape since the early 1800s. While some attributes of the dumbbell have been embellished or slightly modified (e.g., plastic coatings have been added, various color schemes have been used, etc.), these changes have not changed the fundamental character of the dumbbell, and have not addressed the drawbacks associated with that character.

One drawback to classic dumbbells is that they, when used frequently, can cause calluses on the palms of the hands. For many people, and for women in particular, this can prevent consistent use due to a desire to avoid the thick, hardened skin that results. Further, the dumbbell, as with all free weights, is inexorably and psychologically tied to the male-dominated gym for which it was designed. Thus, in most homes, it is undesirable for dumbbells to be stored in plain sight, as their appearance is unsightly and because of the connotations associated with them. As such, most people who own dumbbells store them out of sight (e.g., in a closet, under a bed, etc.), keeping them separated from the “home environment” when not in specific use. Due to the inherent heavy, cumbersome nature of the dumbbell, however, such storage, which requires moving the dumbbells prior to and after each use, is a large disincentive to consistent use. Such storage also dissuades use of the dumbbells due to the age-old “out of sight/out of mind” phenomenon. These drawbacks of the traditional dumbbell can result in less consistent use, and less motivation to use, than is desirable for the health benefits associated with strength training.

As mentioned above, most currently available free weights are psychologically intertwined with the “male pursuit” of weight lifting. This connotation can intimidate many people, and particularly women, who would benefit tremendously from strength training. Thus, those people may not feel comfortable including free weight training in their fitness routine. In short, traditional free weights, and the dumbbell in particular, have many shortcomings which could be improved upon.

### SUMMARY OF THE INVENTION

The present invention addresses drawbacks associated with previously available dumbbells by providing free weights with a comfortable, welcoming and/or enjoyable feel and appearance. This aspect of the presently disclosed free weights can reduce both the occurrence of calluses and user intimidation associated with currently available dumbbells. Furthermore, rather than requiring out of sight storage due to an “appropriate for gym use” appearance, the presently disclosed free weights can be displayed openly in the home, and, as a result, are available for immediate use. This aspect of the current invention makes it more likely that the free weights will be used consistently over time and increases the chance that end users will achieve the health benefits associated with regular strength training.

In particular, one embodiment according to the present invention includes a free weight comprising a material of a predefined weight shaped into a three dimensional curvilinear form. In another embodiment, the curvilinear form is substantially ovoid. In another embodiment, the curvilinear form is extended. In another embodiment, the extended curvilinear form includes bulbed ends. In yet another embodiment, the bulbed ends are substantially similar in shape and weight.

Embodiments according to the present invention also include free weight sets. In one embodiment, the free weight set includes one or more pairs of substantially identical free weights, each free weight including a material of a predefined weight shaped into a three dimensional curvilinear form. The chosen curvilinear form can be one or more of substantially ovoid; extended curvilinear; extended curvilinear with bulbed ends; and/or extended curvilinear with bulbed ends wherein the bulbed ends are substantially similar in shape and weight.

Another free weight set embodiment according to the present invention includes two or more free weights, each free weight including a material of a predefined weight shaped into a three dimensional curvilinear form; and a container for storing and displaying the two or more free weights. In certain embodiments, this container may be bowl-shaped. This free weight set can include three dimensional curvilinear forms selected from the group consisting of substantially ovoid, extended, extended with bulbed ends, extended with bulbed ends wherein said bulbed ends are substantially similar in shape and weight, and combinations thereof.

The free weights according to the present invention can include an inner substrate and an outer coating. In particular embodiments, the inner substrate can include one or more materials selected from the group consisting of iron, cast iron, steel, lead, and concrete. In other embodiments, the outer coating can include one or more materials selected from the group consisting of plastic, vinyl, rubber, polyurethane, neoprene, and chrome. In a particular embodiment, the outer coating is colored. When free weight sets are provided and a colored outer coating is provided, the colored out coating can be the same color or a different color on the weights within the free weight set.

### BRIEF DESCRIPTION OF THE FIGURES

FIG. 1 shows a collection of free weights demonstrating their decorative and storage features according to an embodiment of the present invention.

FIG. 2 shows a user using a free weight according to one specific embodiment of the present invention.

FIG. 3 depicts a side view of the free weight depicted in FIG. 2.

FIG. 4 depicts a rear view of the free weight depicted in FIG. 2.

FIG. 5 shows a user using a free weight according to another specific embodiment of the present invention.

FIG. 6 depicts a rear view of the free weight depicted in FIG. 5.

FIG. 7 depicts a side view of the free weight depicted in FIG. 5.

FIG. 8 shows a user using a free weight according to another specific embodiment of the present invention.

FIG. 9 depicts a side view of the free weight depicted in FIG. 8.

FIG. 10 depicts a rear view the free weight depicted in FIG. 8.

FIG. 11 shows a user using a free weight according to another specific embodiment of the present invention.

FIG. 12 depicts a side view of the free weight depicted in FIG. 11.

FIG. 13 depicts a rear view of the free weight depicted in FIG. 11.

FIG. 14 depicts a cross-section of a free weight according to a specific embodiment of the present invention.

### DETAILED DESCRIPTION

Strength training with free weights provides numerous benefits, including enhancing the quality of life, helping to prevent injury, strengthening bones, lowering the resting metabolism, and promoting general health. Strength training can also provide a much needed confidence boost.

Despite the proven benefits of strength training, not everyone that could benefit from the activity participates in it. This lack of participation could stem from an unease with the appearance of traditional free weights, or from the inconvenience of taking unwieldy and unattractive dumbbells out of storage before each use. The present invention addresses these factors by providing free weights that lack the intimidating appearance of traditional free weights. As a result, the weights described herein need not be stored in between uses, but can be an aesthetic part of the “home environment” instead. The present invention also provides for free weights which can reduce the occurrence of calluses when compared to the traditional dumbbell.

Referring now to the figures, various embodiments of the present invention are shown and further described below. It is to be understood that while words such as “rear profile” and “side profile” will be used to refer to surfaces or sides described herein, these descriptive terms are used only in the context of orientation of the device in the figures under discussion, as during the many exercises for which the weights are designed, they will be used in a multiplicity of orientations.

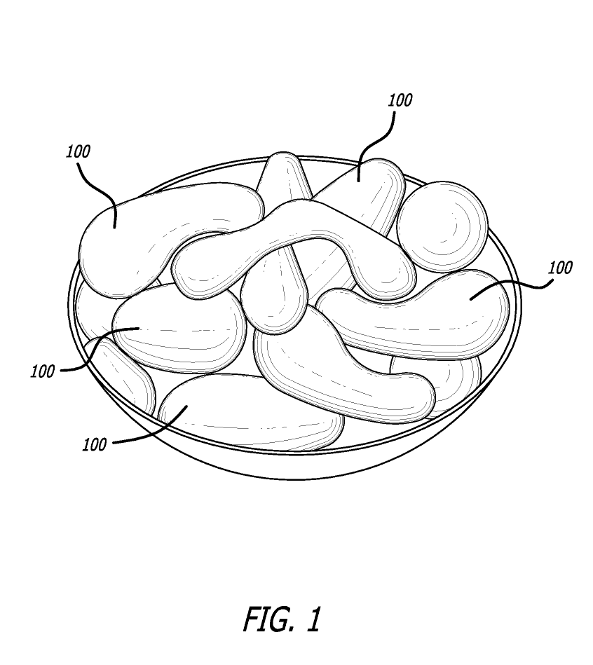

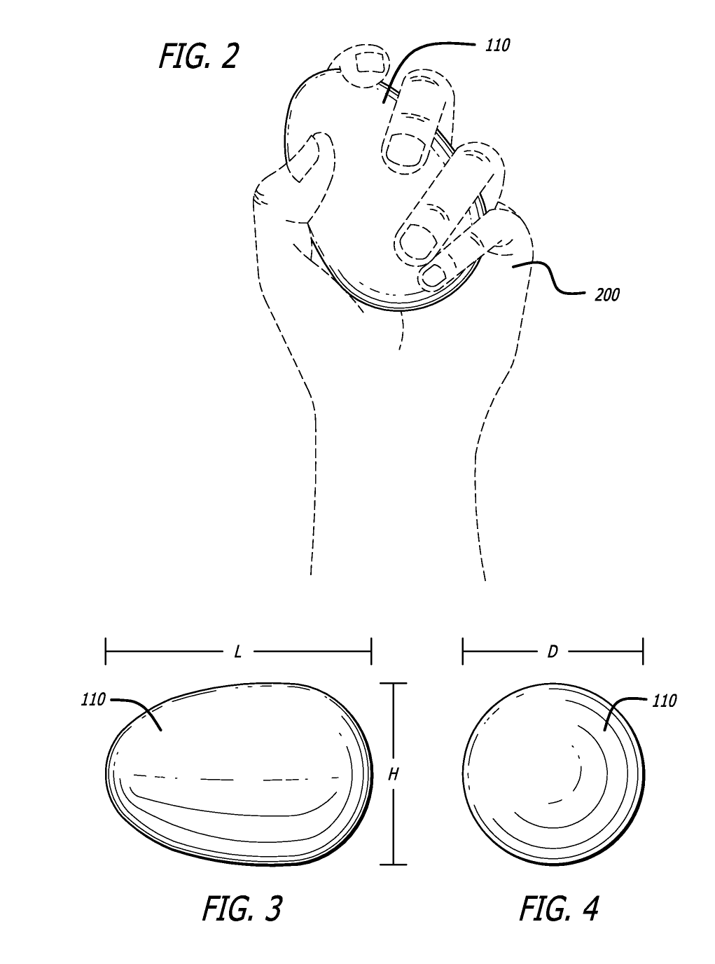

In FIG. 1, a plurality of free weights according to the present invention are displayed in a bowl. As can be seen, each of these free weights 100 lacks the traditional dumbbell shape. Indeed, each free weight 100 may include a material of predefined weight shaped into a three-dimensional curvilinear form (specific, non-limiting embodiments of free weights 100 are depicted in FIGS. 2-13). The advantageous shapes of the free weights 100 help to remove psychological connotations associated with traditional dumbbells. Thus, this feature may help those that would benefit from strength training to engage in it.

The non-traditional, curvilinear forms of the free weights 100 also allow the free weights 100 to be incorporated into a user's everyday living space, as opposed to unsightly conventional free weights, which lack aesthetic appeal and are normally stored out of sight between uses. Thus, as the free weights 100 are more readily available to the user than traditional free weights, the free weights 100 encourage more frequent use for strength training, and consequently better fitness results. Of course, the free weights 100 shown in FIG. 1 need not be displayed in a bowl, but could also be exhibited in other ways, such as, without limitation, upon a shelf, table, tray, or other surface.

Each free weight 100 shown in FIG. 1 may be ergonomically designed to fit comfortably within the hand of a user, as shown for specific embodiments of free weights 100 in FIGS. 2, 5, 8, and 11. These ergonomic designs can act to reduce the development of calluses when compared to traditional dumbbells, and can also act to allow varying sets of flexor muscles and tendons to be exercised while using the same weight. These ergonomic designs also allow each user to find the grip that is most comfortable for them, as opposed to the traditional dumbbell, which forces every user to grasp it in a similar fashion.

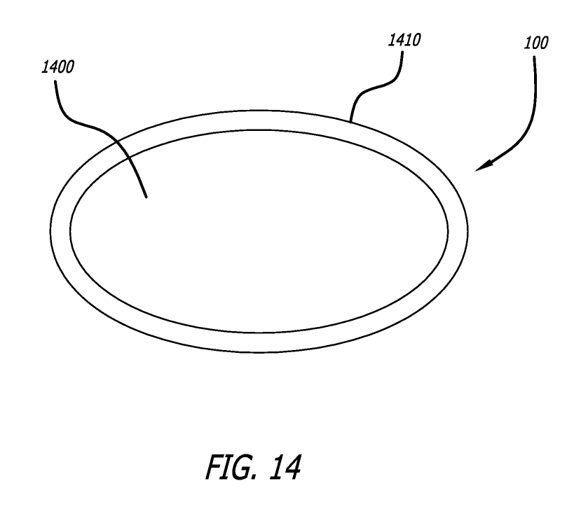

A given free weight 100 may include an inner substrate 1400 surrounded by an outer coating 1410, as shown in FIG. 14. In specific embodiments, the inner substrate 1400 may be designed to provide substantially all of the weight in a free weight 100. Inner substrate 1400 may include, in specific embodiments and not to limit the invention, iron, cast iron, steel, concrete, lead or some other appropriate substance. The weight of inner substrate 1400 may be evenly distributed, or it may be biased to particular portions of a free weight.

Outer coating 1410 may provide several benefits. First, outer coating 1410 may serve as a protective barrier, acting both to prevent the free weight 100 from being scratched, dented, rusted, or otherwise damaged and to reduce any damage caused by the free weight 100 should it be dropped onto the floor or come into contact with some other surface, object, or body part. Second, outer coating 1410 may be colored, so as to add to the aesthetic appeal of the free weight 100, and to allow different free weights 100 to be easily identified. Third, outer coating 1410 may make free weight 100 easier to clean. Fourth, outer coating 1410 may make free weight 100 easier to grip, and may help to reduce the development of calluses. Outer coating 1410 may include, in specific embodiments and not to limit the invention, plastic, vinyl, rubber, polyurethane, neoprene, chrome, or some other appropriate substance. Outer coating 1410 may be varying thicknesses and in particular embodiments can be, without limitation, about 1/16″, about ⅛″ thick, or about ¼″ thick including the ranges between these values.

FIGS. 2 through 13 depict various embodiments of free weights 100 of the present invention. FIGS. 2 through 4 show one specific embodiment of a free weight 100, free weight 110. FIG. 2 shows a user grasping free weight 110 in hand 200. The user might grasp free weight 110 thusly in preparation for completing a strength training exercise such as a bicep curl. As shown in FIG. 2, free weight 110 is designed to fit almost entirely within hand 200 when in use.

FIG. 3 is a side profile rendering of free weight 110. FIG. 4 is a rear profile rendering of free weight 110. As shown in FIGS. 2, 3 and 4, free weight 110 is a three-dimensional substantially ovoid form. In one specific, non-limiting example, free weight 110 measures about 1.94″ in height (H), about 1.94″ in diameter (D) and about 2.88″ in length (L). As will be understood by those of ordinary skill in the art, free weights according to the present invention can come in a variety of altered dimensions, for example, in sizes adapted for varying hand sizes (XS, S, M, L, XL, XXL, etc.).

Free weight 110 can weigh between about 0.5 pounds and about 15 pounds. However, it is contemplated that free weight 110 can have any weight that allows it to be used comfortably and effectively during strength training or some other athletic endeavor. In one specific, non-limiting example, free weight 110 weighs 2 pounds.

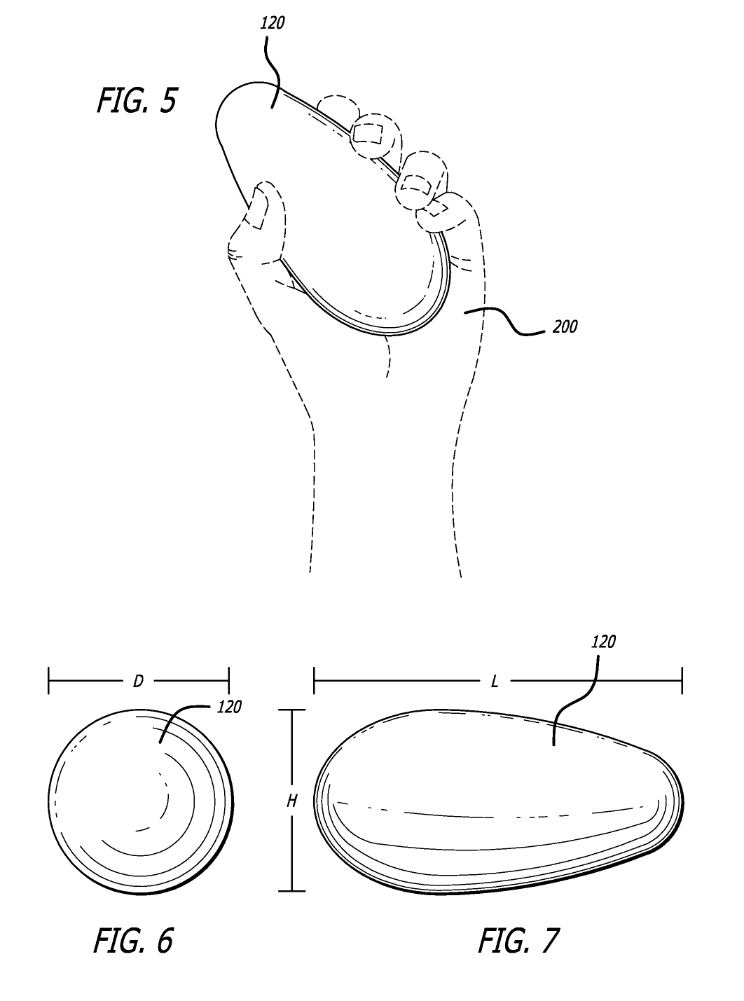

FIGS. 5 through 7 show another specific embodiment of a free weight 100, free weight 120. FIG. 5 shows a user grasping free weight 120 in hand 200. The user might grasp free weight 120 thusly in preparation for completing a strength training exercise such as a bicep curl. As shown in FIG. 5, free weight 120 is designed to fit comfortably, though not entirely, within hand 200 when in use.

FIG. 6 is a rear profile rendering of free weight 110. FIG. 7 is a side profile rendering of free weight 120. As shown in FIGS. 5, 6 and 7, free weight 120 is a three-dimensional elongated substantially ovoid form. In one specific, non-limiting example, free weight 120 measures about 2.29″ in height (H), about 2.33″ diameter (D) and about 4.62″ in length (L). Again, however, these particular dimensions are not required and are provided as an appropriate example.

Free weight 120 can weigh between about 0.5 pounds and about 15 pounds. However, it is contemplated that free weight 120 can have any weight that allows it to be used comfortably and effectively during strength training or some other athletic endeavor. In one specific, non-limiting example, free weight 120 weighs 4 pounds.

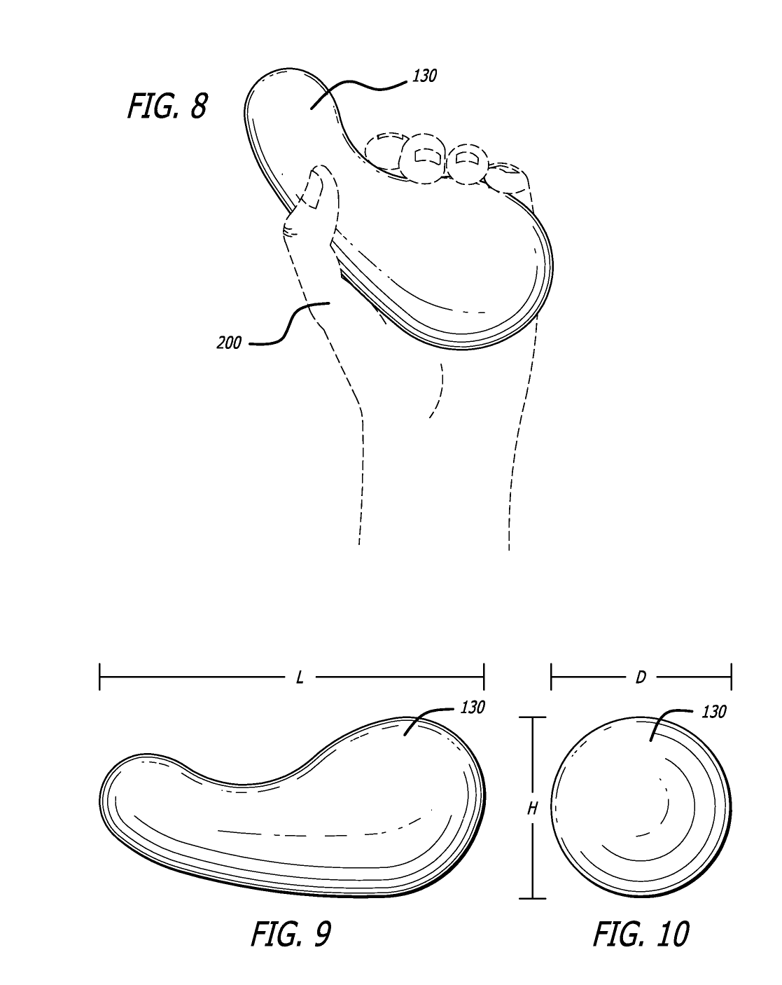

FIGS. 8 through 10 show yet another specific embodiment of a free weight 100, free weight 130. FIG. 8 shows a user grasping free weight 130 in hand 200. The user might grasp free weight 130 thusly in preparation for completing a strength training exercise such as a bicep curl. As shown in FIG. 8, free weight 130 is designed to fit comfortably, though not entirely, within hand 200 when in use.

FIG. 9 is a side profile rendering of free weight 130. FIG. 10 is a rear profile rendering of free weight 130. As shown in FIGS. 8, 9 and 10, free weight 130 is a three-dimensional form that substantially resembles the shape of a gourd—one side is bulbous and the other is tapered with a slight curve. In one specific, non-limiting example, free weight 130 measures about 2.64″ in height (H), about 2.7″ greatest diameter (D) and about 5.86″ in length (L).

Free weight 130 can weigh between about 0.5 pounds and about 15 pounds. However, it is contemplated that free weight 130 can have any weight that allows it to be used comfortably and effectively during strength training or some other athletic endeavor. In one specific, non-limiting example, free weight 130 weighs 6 pounds.

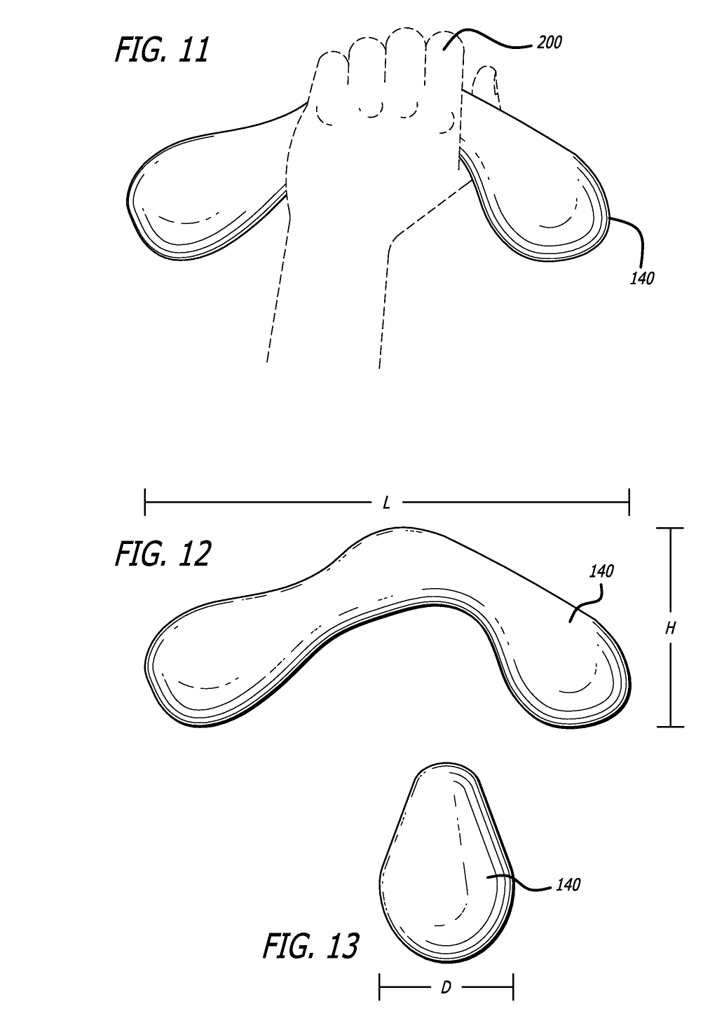

FIGS. 11 through 13 show yet another specific embodiment of a free weight 100, free weight 140. FIG. 11 shows a user grasping free weight 140 in hand 200. The user might grasp free weight 140 thusly in preparation for completing a strength training exercise such as a bicep curl. As shown in FIG. 11, free weight 140 is designed to fit comfortably, though not entirely, within hand 200 when in use.

FIG. 12 is a side profile rendering of free weight 140. FIG. 13 is a rear profile rendering of free weight 140. As shown in FIGS. 11, 12 and 13, free weight 140 is a three-dimensional form that has curved, asymmetrical ends of similar weights. In one specific, non-limiting example, free weight 140 measures about 4.14″ in height (H), about 2.78″ greatest diameter (D) and about 10.05″ in length (L).

Free weight 140 can weigh between about 0.5 pounds and about 15 pounds. However, it is contemplated that free weight 140 can have any weight that allows it to be used comfortably and effectively by a user during strength training or any other athletic endeavor. In one specific, non-limiting example, free weight 140 weighs 8 pounds.

The specific embodiments of free weights 100 shown in FIGS. 2-13 are provided solely as examples of the present invention, and are not intended to limit the invention in any way.

Other embodiments of the present invention are free weight sets including two or more free weights 100. One such embodiment includes two identical free weights 100 (which may be free weights 110, 120, 130, or 140). Another such embodiment includes two or more free weights 100, which may or may not be identical. One specific such embodiment includes one or more free weight 110, one or more free weight 120, one or more free weight 130, and one or more free weight 140, as described above. However, it is contemplated that the free weight sets of the present invention are not limited to any particular number or combination of free weights.

As described above, free weight sets of the present invention can be displayed in a decorative fashion, such as in a bowl or on a shelf, table, or counter. In this way, the free weights 100 of the present invention can act as decoration as well as a functional strength training product. Furthermore, the decorative aspects of the free weights 100 of the invention allow the weights to be part of the “home environment” and provide an aesthetic that is welcoming to users, which can further promote the use of the free weights. The geometry of the weights facilitates their relative spatial positioning and aesthetic appeal.

The following examples are meant to illustrate one or more embodiments of the invention and are not meant to limit the invention to that which is described below.

### EXAMPLE 1

A study will be undertaken to evaluate the effectiveness and enthusiasm of the forms and manageability of the present inventions in the health of women. The objective of the study will be to determine whether women feel more comfortable using the present invention and are more likely to use them compared to currently available traditional free weights.

A study will be done with 120 women subjects over a period of 6 months. Women who have never strength trained are selected. Some may do or have done forms of cardiovascular exercise occasionally. None exercise regularly. They range in age from 18 to 70.

An initial assessment of the health and fitness level of each subject will be conducted by a physician before the women begin the study.

The 120 subjects chosen for the study will be separated into two groups of 60. The average age and level of health will be similar in both groups. The first group will be given a set of free weights in accordance with certain embodiments of the present invention. The second group will be given four pairs of traditional dumbbells, in weights of two, five, eight, and ten pounds. Both groups will be provided with printed instructions on the use of their weights, as well as a DVD tutorial on strength training.

Subjects will be given a journal to record their sessions in terms of frequency of activity, type of exercise and number of repetitions. They will meet with the same physician every two weeks for the 6 month test period to monitor their health in terms of body fat percentage, weight, blood pressure and bone density. Their overall strength and grip strength will also be tested. They will also report their energy level and their general wellbeing.

The subjects from both groups will be evaluated to see both the improvement of health based on body fat percentage, weight, blood pressure, and bone density, as well as overall strength and grip strength. Energy level and general wellbeing will also be evaluated. The frequency of strength training from each subject's journals will be recorded and cataloged.

Upon conclusion of the study, an improvement in the specific aspects of health measured will be observed in the subjects in the first group (who were given the free weights of the present invention) over the second group (who were given traditional dumbbells) upon completion of the study. The patients' evaluations will find that those using the free weights of the present invention rate their health as more improved than those using the traditional dumbbell. The evaluations made by the treating physicians will also show that the frequency of use was greater for those using the free weights of the present invention versus the traditional dumbbell, thus explaining those subjects improved health, fitness, strength and wellbeing. This study will demonstrate that the women studied are more likely to use the free weights of the present invention than traditional dumbbells, and that their health is measurably better due to the more consistent strength training that comes along with use of the free weights of the present invention.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Specific embodiments of this invention are described herein, including the best mode known to the inventors for carrying out the invention. Of course, variations on these embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A free weight comprising a material of a predefined weight shaped into a three dimensional curvilinear form.

2. The free weight of claim 1 wherein the curvilinear form is substantially ovoid.

3. The free weight of claim 1 wherein the curvilinear form is extended.

4. The free weight set of claim 3 wherein said extended curvilinear form comprises bulbed ends.

5. The free weight set 4 wherein said bulbed ends are substantially similar in shape and weight.

6. The free weight of claim 1 further comprising an inner substrate and an outer coating.

7. The free weight of claim 6 wherein said inner substrate comprises one or more materials selected from the group consisting of iron, cast iron, steel, lead, and concrete.

8. The free weight of claim 6 wherein said outer coating comprises one or more materials selected from the group consisting of plastic, vinyl, rubber, polyurethane, neoprene, and chrome.

9. The free weight of claim 6 wherein said outer coating is colored.

10. A free weight set comprising one or more pairs of substantially identical free weights, each free weight comprising a material of a predefined weight shaped into a three dimensional curvilinear form.

11. The free weight set of claim 10 wherein each free weight further comprises an inner substrate and an outer coating.

12. The free weight set of claim 11 wherein said inner substrate of each free weight comprises one or more materials selected from the group consisting of iron, cast iron, steel, lead, and concrete.

13. The free weight set of claim 11 wherein said outer coating of each free weight comprises one or more materials selected from the group consisting of plastic, vinyl, rubber, polyurethane, neoprene, and chrome.

14. The free weight set of claim 11 wherein said outer coating of each free weight is colored.

15. A free weight set comprising:
two or more free weights, each free weight comprising a material of a predefined weight shaped into a three dimensional curvilinear form; and
a container for storing and displaying the two or more free weights.

16. The free weight set of claim 15 wherein said three dimensional curvilinear form is selected from the group consisting of substantially ovoid, extended, extended with bulbed ends, extended with bulbed ends wherein said bulbed ends are substantially similar in shape and weight, and combinations thereof.

17. The free weight set of claim 15 wherein each free weight further comprises an inner substrate and an outer coating.

18. The free weight set of claim 15 wherein said inner substrate of each free weight comprises one or more materials selected from the group consisting of iron, cast iron, steel, lead, and concrete.

19. The free weight set of claim 15 wherein said outer coating of each free weight comprises one or more materials selected from the group consisting of plastic, vinyl, rubber, polyurethane, neoprene, and chrome.

20. The free weight set of claim 15 wherein said outer coating of each free weight is colored.
